(19) United States
(12) Patent Application Publication
(10) Pub. No.: US 2005/0135871 A1
(43) Pub. Date: Jun. 23, 2005

(54) Ring binder mechanism with pronged metal anchors

(75) Inventor: Chung Nin Ko, Kowloon (CN)

Correspondence Address: SHOEMAKER AND MATTARE, LTD, 10 POST OFFICE ROAD - SUITE 110, SILVER SPRING, MD, 20910, US

(73) Assignee: Hong Kong Stationery Manufacturing Co., Ltd., Kowloon (HK)

(21) Appl. No.: 10/739,406

(22) Filed: Dec. 19, 2003

(51) Int. Cl. B42F 3/00

(52) U.S. Cl. 402/70

(57) ABSTRACT

A ring binder mechanism is attached to the spine of a notebook by pressing prongs of pre-attached anchors into the spine material. The prongs are curved outward slightly, and are thinner than the centers of the anchors, so that they spread outward as force is applied to the anchors. The prongs are arranged in two sets which face in opposite directions. Anchors so constructed provide good retention force while requiring a minimum application force, and cannot be seen from outside the binder.

### BACKGROUND OF THE INVENTION

This invention relates to a ring binder mechanism having pronged metal anchors for attaching the mechanism to a binder.

A typical ring binder mechanism has plural pairs of moveable ring halves supported by a sheet metal housing. A pair of eyelets, whose upper ends are riveted in holes of the housing, extend downward from the housing. To secure the ring mechanism to a loose-leaf binder, two external rivets are inserted through the eyelets of the housing from the outside of the binder by a riveter.

It is unpleasant to see exposed rivet heads on a closed binder. Moreover, if the ring mechanism is riveted to a clear vinyl overlay binder, the rivet heads usually cause resistance to the labeling sheet when it is inserted into the clear vinyl pocket. Some prior constructions hide the rivet head inside a closed binder and require no external rivet when securing the ring binder mechanism onto a binder.

One known way to secure ring mechanisms to a notebook spine is, rather than using through rivets, to use pronged anchors which penetrate the spine only partly, and do not show from the outside of the notebook. But these anchors do not always provide enough retention force, even though they may be pressed against the spine with a large application force.

To maximize the resistance to detachment of the ring mechanism from the binder, the principle is to spread the prongs as wide as possible. As the prongs spread, the total horizontal area covered by the prongs inside the chipboard increases. When a pullout force is applied, tending to shear the chipboard above the prongs along a shearing boundary, it is resisted by a shearing reaction force at that boundary. The maximum reaction force that the chipboard can produce is directly proportional to the length of the boundary traced by the sharp points of prongs, the shear strength of the chipboard, and the thickness of the chipboard.

### SUMMARY OF THE INVENTION

The primary objective of the invention is to hide the rivet head and to simplify the process of securing the ring mechanism to a typical binder.

A related goal is to construct an anchor that can penetrate the chipboard of the binder when the eyelets are pressed towards the chipboard, while minimizing the required pressing force.

A further object is to maximize the retention force of such an anchor.

The above objectives are attained by a ring binder mechanism having pronged metal anchors, as described in the following description.

Since, with this invention, the prongs are submerged in the chipboard, no additional rivet is needed to fix the ring mechanism with the pronged anchor to the chipboard. And because neither a rivet head nor a pronged metal anchor shows from the outside of a closed binder, the appearance of the binder is enhanced, and there is no resistance to insertion of the title sheet when using a clear vinyl overlay binder.

The present construction minimizes the force needed to secure the ring mechanism to the binder and maximizes the force required to detach it. The force required to secure the ring mechanism affects to the cost of the manufacturing process; the force required to remove the ring mechanism from the binder determines the security of the loose leaf papers holding in the binder.

### BRIEF DESCRIPTION OF THE DRAWINGS

In the accompanying drawings,

FIG. 1 is a top plan view of a pronged metal anchor embodying the invention, before deformation;

FIG. 2 is a sectional view thereof taken on the plane 2-2 in FIG. 1;

FIG. 3 is a top plan view of the pronged metal anchor after deformation;

FIG. 4 is a sectional view thereof taken on the plane 4-4 in FIG. 3;

FIG. 5 is an isometric view thereof;

FIG. 6 is a side elevation of a ring binder mechanism having pronged anchors according to the invention rivet to eyelets at either end of the mechanism;

FIG. 7 is an end view thereof;

FIG. 8 is an enlarged side view thereof;

FIG. 9 diagrams the force system acting on a pronged metal anchor as it is pressed into the chipboard; and

FIG. 10 is a sectional view showing the pronged metal anchors submerged in the chipboard spine of a binder.

### DESCRIPTION OF THE PREFERRED EMBODIMENT

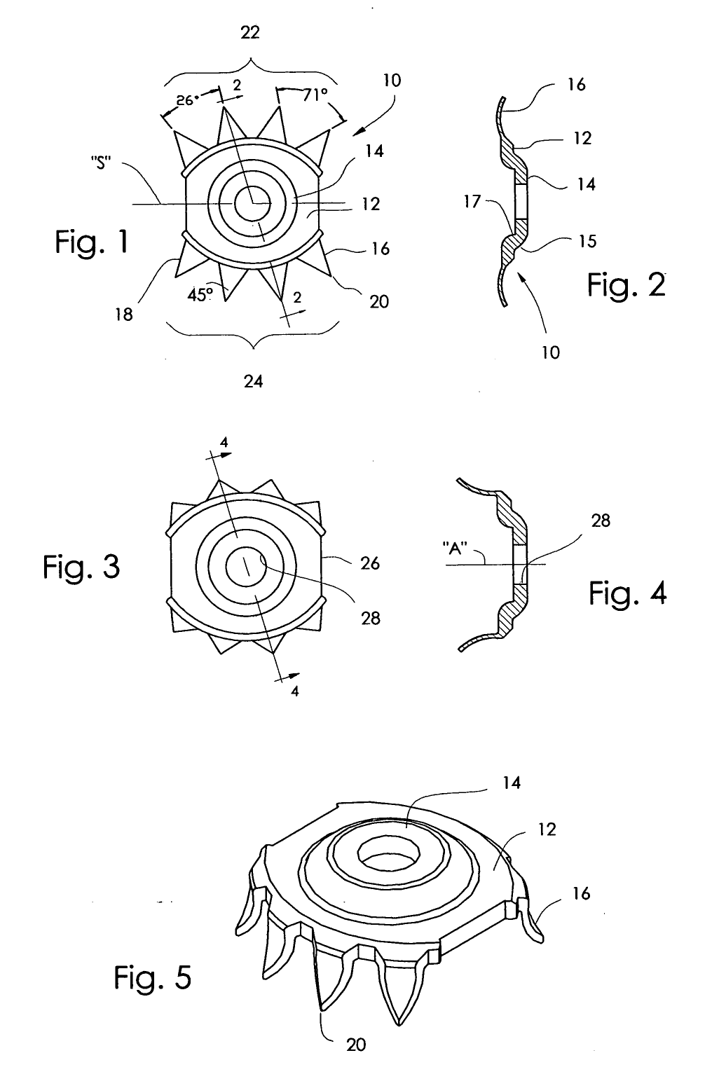

According to this invention, a pronged anchor 10 is formed by stamping a small metal plate into the shape shown in FIG. 1. The pronged plate has an annular outer portion 12, a raised central portion 14 defined by a circular step 15, and a plurality of prongs 16 extending outward from the outer portion. The step also defines a shallow recess 17 on the bottom of the plate. Note (FIG. 2) that the prongs are substantially thinner—actually, less than half as thick as—the rest of the plate.

Each of the prongs has lateral sides 18 which subtend an angle 45° (FIG. 1) with each other and meet at the prong's tip 20. The included angle between the sides of adjacent prongs is about 71°. The prongs are arranged in two sets 22, 24 which extend in opposite directions from a plane of symmetry “S”. Within each set, the prongs diverge, having equiangular spacing of about 26° (FIG. 1) about respective centers which lie beyond the center of the hole. The prongs do not extend 360° around the axis “A” (FIG. 3) of the center hole 28. Rather, the two sets 22, 24 point generally in opposite directions, rather than in all directions. Note that the outer portion 12 is cut off at either end 26, where there are no prongs.

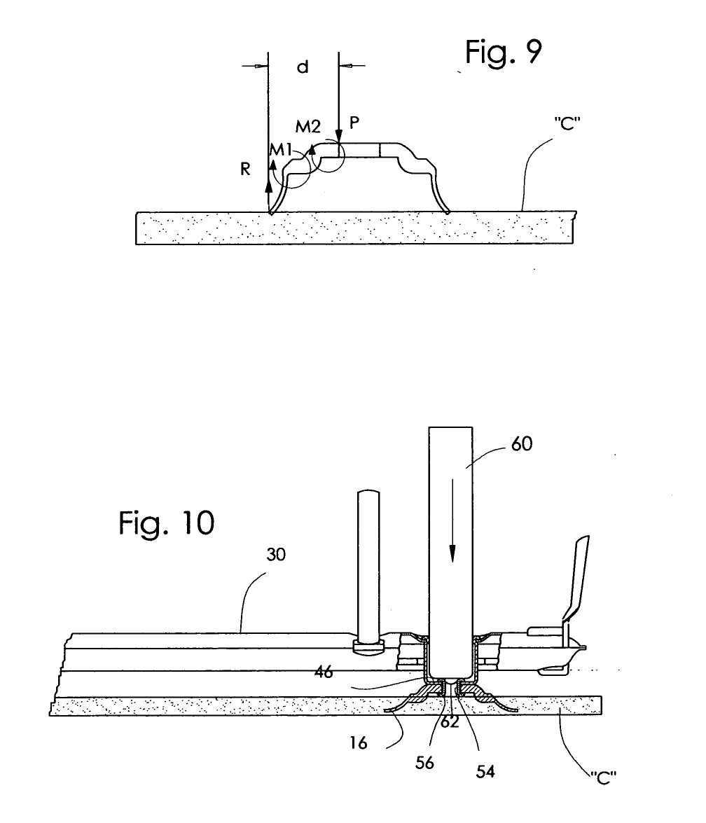

The prongs are given a slight outward curvature (with a radius of curvature of about 4.6 mm). They are bent downward during manufacture, as shown in FIGS. 4 and 5, so that their tips are inclined 45°, plus or minus two degrees, to a plane perpendicular to the axis “A”. That plane corresponds to the surface of a chipboard “C” (FIG. 9) in practice.

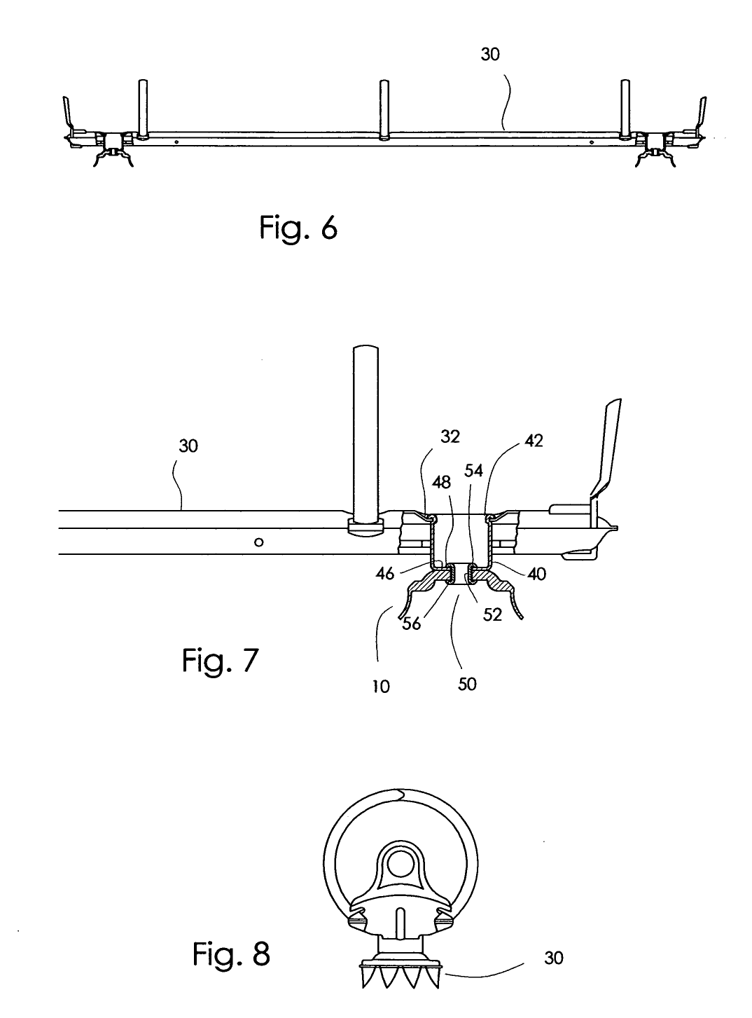

The prong plates are pre-assembled to a ring binder mechanism 30 (FIGS. 6-8), which has mounting holes 32 at either end, by means of an eyelet 40 and a rivet 50 (FIG. 7). The eyelet is open-mouthed at its upper end 42, which is swaged around the edge of the mounting hole 32 in the mechanism. The bottom end of the eyelet is partially closed by a circumferential flange 46 which is bent inward 90°, and defines a bottom aperture 48.

The open-ended rivet 50 shown in FIG. 6 has a shaft 52 which just fits through both the bottom aperture of the eyelet and the hole 28 in the pronged anchor. The upper end 54 of the rivet is deformed outward to form a head which will not pass through the aperture 48 in the eyelet. The anchor is secured to the bottom of the eyelet by deforming the lower end 56 of the rivet (FIG. 7) while the anchor and the eyelet are pressed together.

To secure the assembled ring mechanism to the chipboard of the binder, force is applied to the base flat of each eyelet with a punch-like tool 60 (FIG. 10) whose diameter is slightly less than the inner diameter of the eyelet. The tool has a protruding nose 62 surrounded by a perimeter which bears against the top end of the rivet, applying force to the anchor at the circular locus represented by the large arrow “P” in FIG. 9. This force in turn presses the prong points into the chipboard “C” of a binder.

The circular prongs stab into the layer of the chipboard at an attack angle of 45°. Thus half of the vertical pressing force is used to penetrate the chipboard, and half of the force transfers to the horizontal direction to flatten the prongs as they penetrate the chipboard. The prong tips penetrate the chipboard easily, achieving the goal of minimizing the force needed to secure the ring mechanism properly. Once the prongs have penetrated the surface of the chipboard, they begin to spread and are bent upward by the contact reaction force as they submerge into the chipboard.

As the prongs spread, the reaction forces—which always act perpendicular to the surface of the prongs—change direction. The tips of the prongs follow an arcuate path, corresponding to their own curvature, within the chipboard. The prongs never resurface. As a result, no portion of the prongs shows from outside the binder.

The stepped structure of the cross section of the pronged metal provides sufficient structural stiffness for transmitting the bending moments M₁ and M₂, where M₁=M₂=P*d, as illustrated in FIG. 5. The bending of the junctions produces horizontal movement of the prongs. Moreover, the stepped structure increases the offset distance “d” between the action force P and the reaction force R. This way, the bending moments M₁ and M₂ are maximized so as to maximize the spreading effect of the prongs.

To test the security of pronged anchors according to this invention, a quantity of pronged anchors were applied to 120 point (3 mm thick) chipboards, and then were pulled off the chipboards while the pulling force was measured. The pulling forces ranged from a minimum of 24 kg to a maximum of 34 kg, the average being 29 kg. Even the minimum retention force observed is more than adequate to securely retain a ring mechanism to its binder.

Since the invention is subject to many variations and changes in detail, it is intended that the foregoing description and the drawings, including any linear or angular dimensions recited, shall be interpreted as merely illustrative of the invention defined by the claims below.

1. An anchor for attaching a ring binder mechanism to a spine of a notebook said anchor comprising
a metal plate having a center portion with a hole therein for receiving a rivet, the central portion having a first thickness, and a plurality of prongs extending from the center portion, each of said prongs having a second thickness less than half said first thickness, and a pointed tip.

2. The invention of claim 1, wherein said prongs are arranged in two sets on opposite sides of a plane of symmetry containing said center.

3. The invention of claim 2, wherein said prongs are arranged only on either side of said plane, and each prong extends in a direction substantially away from said plane.

4. The invention of claim 1, wherein each prong is bent downward from a plane perpendicular to the axis of the anchor at an angle such that the pointed tip of each prong makes an angle of about 45° with a plane containing said tips.

5. The invention of claim 4, wherein said angle is between 43° and 47°.

6. The invention of claim 1, wherein each of said prongs has sides which taper toward said tip, the included angle between opposing sides of adjacent tips being about 71°.

7. The invention of claim 1, wherein adjacent prongs on either side of said plane of symmetry extend in directions which subtend an angle of about 26°.

8. The invention of claim 1, wherein the center portion has an annular step defining an inner raised portion and an outer annular portion, the prongs extending from the outer annular portion.

9. The invention of claim 1, wherein each prong has an outward curvature to enable it to follow an arcuate path within the spine when the prongs arc pressed into the spine.

10. The invention of claim 9, wherein the curvature has a radius of about 4.6 mm.

11. A ring binder mechanism having
a metal casing having a pair of mounting holes therein,
a pair of eyelets, each having an upper end secured within a respective mounting hole, and a lower end having an internal circumferential flange defining a circular bottom opening,
a pair of rivets, each having a head larger in diameter than said bottom opening and a shaft which fits through said bottom opening, and
a pair of prong plates, each having a center portion with a hole at its center, and a plurality of prongs extending away from said center portion, each of said prongs having a thickness less than half that of said center portion,
the rivet shaft extending through the hole in the prong plate and being deformed at its end opposite its head so as to retain the prong plate to the eyelet.

12. The invention of claim 11, wherein said prongs are arranged symmetrically about a plane of symmetry containing said center.

13. The invention of claim 12, wherein said prongs are arranged only on either side of said plane, and each prong extends in a direction substantially away from said plane.

14. The invention of claim 11, wherein each prong extends downward from a plane perpendicular to the axis of the anchor at an angle such that the pointed tip of each prong makes an angle of about 45° with a plane containing said tips.

15. The invention of claim 11, wherein the center portion has an annular step defining a central recess at the bottom of the prong plate for receiving the deformed end of the rivet.
